(19) United States
(12) Patent Application Publication
(10) Pub. No.: US 2023/0375869 A1
(43) Pub. Date: Nov. 23, 2023

(54) DISPLAY DEVICE AND MIRROR DEVICE

(71) Applicant: Panasonic Intellectual Property Management Co., Ltd., Osaka (JP)

(72) Inventors: Tsubasa KITAZUMI, Osaka (JP); Ryouji ONISHI, Osaka (JP); Takamitsu ISONO, Osaka (JP); Shigeru ARUGA, Osaka (JP); Kouji TERAWAKI, Osaka (JP)

(21) Appl. No.: 18/030,937

(22) PCT Filed: Oct. 5, 2021
(86) PCT No.: PCT/JP2021/036840

§ 371 Date: Apr. 7, 2023

Related U.S. Application Data
(60) Provisional application No. 63/092,696, filed on Oct. 16, 2020.

(30) Foreign Application Priority Data
Nov. 27, 2020 (JP) 2020-196834

(51) Int. Cl. G02F 1/1335; G02F 1/01; G02F 1/1347; G02F 1/137

(52) U.S. Cl. CPC G02F 1/133502; G02F 1/0136; G02F 1/13478; G02F 1/137; A47G 1/02

(57) ABSTRACT

A display device includes: a mirror body; a display component; and a mirror component disposed between the mirror body and the display component and switchable between a transmitting state in which external light and picture light are transmitted and a reflecting state in which the external light passing through the mirror body is reflected. The mirror body includes: a substrate transparent to light; an absorptive polarizer covering a first region not including the mirror component or the display component and a second region including the mirror component and the display component in plan view; and a reflective polarizer disposed on a rear face of the substrate and including an opening in the second region. The mirror component includes: a liquid crystal layer capable of changing a polarization direction of the external light; and a reflective polarizer disposed on a side of the liquid crystal layer adjacent to the display component.

### TECHNICAL FIELD

The present disclosure relates to a display device and a mirror device.

### BACKGROUND ART

Washstand systems (display devices) that can project pictures on mirrors (mirror bodies) of washstands have been known recently. Patent Literature (PTL) 1 discloses a washstand system that includes a one-way mirror and a display (display component) disposed at the back of the one-way mirror and that can project pictures through the one-way mirror using the one-way mirror and the display.

### CITATION LIST

### Patent Literature

### [PTL 1]

Japanese Unexamined Patent Application Publication No. 2019-153071

### SUMMARY OF INVENTION

### Technical Problem

However, the washstand system disclosed in PTL 1 displays pictures through the one-way mirror, and the pictures are thus affected by reflection of external light. This reduces the visibility of the pictures. To inhibit reflection of external light, display devices including a digital mirror (for example, liquid crystal device) that is disposed in front of a display and that can switch between a transmission mode (display mode) and a reflection mode (mirror mode) have been considered. However, in a case where such a display device includes a digital mirror and a display that are small relative to a mirror in plan view, reflected images appear differently in the region with the digital mirror and that without the digital mirror. This reduces the visibility of the reflected images.

In view of this, the present disclosure provides a display device and a mirror device capable of increasing the visibility of reflected images while inhibiting reflection of external light.

### Solution to Problem

A display device according to an aspect of the present disclosure is a display device including: a mirror body that reflects part of external light; a display component that emits picture light for displaying a picture; and a mirror component disposed between the mirror body and the display component and switchable between a transmitting state in which the mirror component transmits the external light that has passed through the mirror body and the picture light and a reflecting state in which the mirror component reflects the external light that has passed through the mirror body, wherein the mirror component and the display component are disposed to at least partially overlap each other in a plan view which is a view seen in an alignment direction in which the mirror body, the mirror component, and the display component are aligned, and the mirror body is larger than the mirror component and the display component in the plan view, the mirror body includes: a plate-shaped member having transparency to light; an absorptive polarizer disposed on a surface of the plate-shaped member and covering both a first region in which the mirror component and the display component are not disposed and a second region in which the mirror component and the display component are disposed in the plan view; and a first reflective polarizer disposed on a side of the plate-shaped member adjacent to the mirror component, including an opening in the second region in the plan view, and reflecting the part of the external light, and the mirror component includes: a switcher capable of switching the mirror component between the transmitting state and the reflecting state by changing a polarization direction of incident light; and a second reflective polarizer disposed on a side of the switcher adjacent to the display component and capable of reflecting the external light that has passed through the mirror body.

A mirror device according to an aspect of the present disclosure is a mirror device for use in a display device, the mirror device including: a switcher that includes a first main surface which light vibrating in a predetermined direction enters, and that is capable of switching the mirror device between a transmitting state and a reflecting state by changing a polarization direction of the light that has entered the first main surface, the transmitting state being a state in which the mirror device transmits the light and the reflecting state being a state in which the mirror device reflects the light; and a reflective polarizer disposed on a second main surface of the switcher that faces a direction opposite to the first main surface and capable of reflecting the light that has passed through the switcher, wherein the mirror device includes only the reflective polarizer out of an absorptive polarizer and the reflective polarizer.

### Advantageous Effects of Invention

A display device and so on according to an aspect of the present disclosure are capable of increasing the visibility of reflected images while inhibiting reflection of external light.

### BRIEF DESCRIPTION OF DRAWINGS

FIG. 1 is a perspective view of an external appearance of a display device according to an embodiment.

FIG. 2 is a cross-sectional view, taken along line II-II in FIG. 1, of the display device according to the embodiment.

FIG. 3 is a block diagram illustrating a functional configuration of the display device according to the embodiment.

FIG. 4A is a schematic diagram illustrating how light travels when the display device according to the embodiment is in a reflection mode.

FIG. 4B is a schematic diagram of the appearance of the display device according to the embodiment in the reflection mode.

FIG. 5A is a schematic diagram illustrating how light travels when the display device according to the embodiment is in a display mode.

FIG. 5B is a schematic diagram of the appearance of the display device according to the embodiment in the display mode.

FIG. 6A is a schematic diagram illustrating how light travels when a display device according to a comparative example is in a reflection mode.

FIG. 6B is a schematic diagram of the appearance of the display device according to the comparative example in the reflection mode.

FIG. 7 is a cross-sectional view, corresponding to line II-II in FIG. 1, of a display device according to Variation 1 of the embodiment.

FIG. 8 is a cross-sectional view, corresponding to line II-II in FIG. 1, of a display device according to Variation 2 of the embodiment.

FIG. 9 is a cross-sectional view, corresponding to line II-II in FIG. 1, of a display device according to Variation 3 of the embodiment.

### DESCRIPTION OF EMBODIMENT

Hereinafter, an embodiment of the present disclosure will be described in detail with reference to the accompanying drawings. The embodiment described below illustrates a specific example of the present disclosure. Therefore, the numerical values, shapes, materials, constituent elements, the arrangement and connection of the constituent elements, etc. illustrated in the embodiment below are mere examples, and do not intend to limit the present disclosure. Accordingly, among the constituent elements included in the embodiment below, constituent elements not recited in any of the independent claims representing the most generic concepts of the present disclosure will be described as optional constituent elements.

Note that the drawings are represented schematically and are not necessarily precise illustrations. In addition, in the drawings, essentially the same constituent elements share the same reference signs, and redundant descriptions will be omitted or simplified.

In the Specification, numerical values, numerical ranges, terms representing relationships between elements such as “identical”, “equal”, “same”, and “orthogonal”, and terms representing the shapes of elements such as “rectangular” do not represent their strict meanings only, but include a substantially equivalent range, for example deviations of about a few percent.

In the drawings, for example, an X-axis direction is a direction perpendicular to the surface of a display device. A Y-axis direction and a Z-axis direction are orthogonal to each other and are also orthogonal to the X-axis direction. For example, in the following embodiment, “plan view” refers to viewing in the X-axis direction. Moreover, in the following embodiment, “sectional view” refers to viewing a section, taken by cutting the display device along a plane orthogonal to the surface of the display device (for example, a plane defined by the X-axis and the Z-axis), in a direction orthogonal to the section (for example, in the Y-axis direction).

### Embodiment

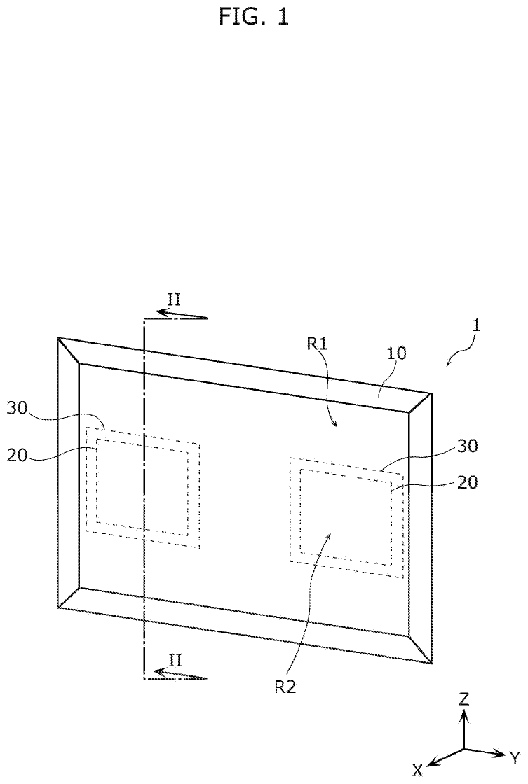

A display device according to the present embodiment will now be described with reference to FIGS. 1 to 6B.

### [1. Structure of Display Device]

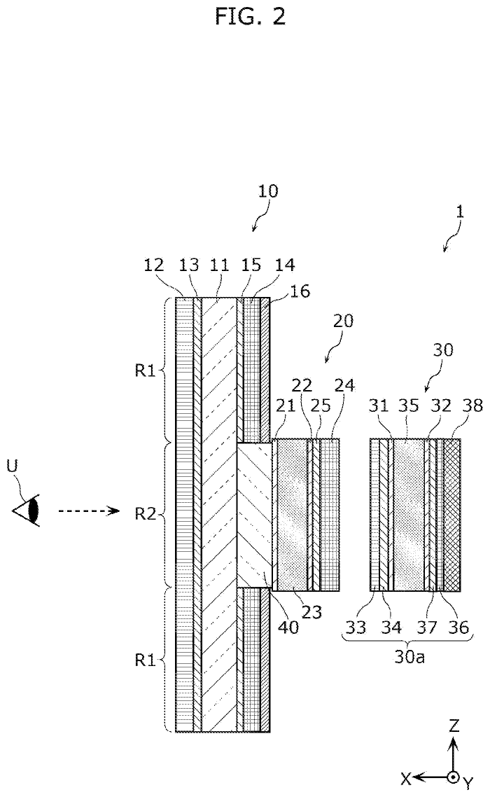

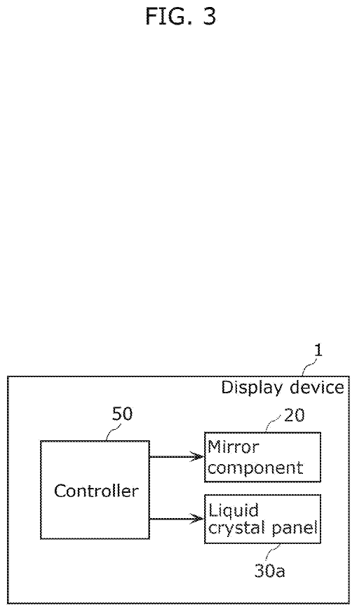

First, a structure of the display device according to the present embodiment will be described with reference to FIGS. 1 to 3. FIG. 1 is a perspective view of an external appearance of display device 1 according to the present embodiment. FIG. 2 is a cross-sectional view, taken along line II-II in FIG. 1, of display device 1 according to the present embodiment. FIG. 3 is a block diagram illustrating a functional configuration of display device 1 according to the present embodiment. Display device 1 according to the present embodiment can be used as, but not limited to, washstand mirrors, for example, and can be used for objects that project reflected images (mirror images). For example, display device 1 may be used for mirrors disposed inside vehicles (so-called rearview mirrors).

As illustrated in FIGS. 1 to 3, display device 1 includes mirror body 10, mirror component 20, display component 30, resin layer 40, and controller 50. Display device 1 includes mirror body 10 in front (on a positive X-axis side) of display component 30. In the example illustrated in FIG. 1, display device 1 includes two sets of mirror component 20 and display component 30. However, display device 1 need only include one or more sets of mirror component 20 and display component 30.

Mirror body 10 is disposed in front of mirror component 20 and display component 30 and has a function of reflecting part of light (external light) that has entered display device 1 from the outside. Note that the external light herein refers to light other than that emitted from display component 30 of display device 1. Such light includes, but not limited to, illuminating light and sunlight.

In plan view, mirror body 10 is larger than mirror component 20 and display component 30. Mirror body 10 has first region R1 that does not overlap mirror component 20 and display component 30 and second region R2 that overlaps mirror component 20 and display component 30. In plan view, first region R1 is a region where no picture is displayed in display device 1 and that functions as a mirror in display device 1. In plan view, for example, first region R1 is a region other than second region R2. In plan view, second region R2 is a region where pictures can be displayed, that functions as a mirror in display device 1, and that functions as a screen where pictures are displayed.

Moreover, first region R1 is a region from which incident external light can be reflected, and second region R2 is a region through which incident external light can pass. For example, in a display mode (described below), first region R1 in mirror body 10 has a higher reflectance of incident external light than second region R2 in mirror body 10. Moreover, for example, in the display mode, second region R2 in mirror body 10 has a higher transmittance of incident external light than first region R1 in mirror body 10. That is, mirror body 10 reflects part of incident external light and allows the rest of external light to pass through mirror body 10. First region R1 and second region R2 form the surface of mirror body 10 (for example, screen of display device 1). Note that pictures may be moving pictures or still pictures.

Mirror body 10 includes substrate 11, absorptive polarizer 12, adhesive layer 13, reflective polarizer 14, adhesive layer 15, and light blocking layer 16. Mirror body 10 according to the present embodiment includes absorptive polarizer 12, adhesive layer 13, substrate 11, adhesive layer 15, reflective polarizer 14, and light blocking layer 16 aligned in the stated order. It can also be said that the X-axis direction is an alignment direction (direction of lamination) of constituent elements that constitute mirror body 10. In plan view, mirror body 10 has, but not limited to, a rectangular shape.

Substrate 11 is a plate-shaped member having transparency to light, such as a transparent substrate composed of glass or resin (for example, acrylic resin). For example, the surface of substrate 11 is smooth. Note that substrate 21 is an example of a substrate, of a pair of substrates, which is adjacent to mirror body 10.

Here, in the Specification, “having transparency to light” refers to, for example, having a visible light transmittance of 10% or more.

Absorptive polarizer 12 is an optical member disposed on the surface of substrate 11 to absorb light, in incident light (for example, external light), that vibrates in an absorption axis direction. In the present embodiment, absorptive polarizer 12 is disposed on a surface of substrate 11 on the front side (positive X-axis side) of substrate 11 opposite a side on which mirror component 20 is disposed. In plan view, absorptive polarizer 12 extends over first region R1 and second region R2. In the present embodiment, absorptive polarizer 12 covers entire first region R1 and second region R2. It can also be said that absorptive polarizer 12 covers the entire front surface of substrate 11.

Optical properties (for example, transmittance, absorption axis, hue, and the like) of a first part of absorptive polarizer 12 covering first region R1 and optical properties (for example, transmittance, absorption axis, hue, and the like) of a second part of absorptive polarizer 12 covering second region R2 are, for example, identical. In absorptive polarizer 12, the first part and the second part are formed in an integrated manner.

To obtain bright pictures and bright reflected images, it is desirable that absorptive polarizer 12 have a high transmittance. It is desirable that the transmittance of absorptive polarizer 12 alone be 40% or more, more preferably 42% or more.

Adhesive layer 13 is an adhesive member for affixing absorptive polarizer 12 to substrate 11. Specifically, adhesive layer 13 affixes the rear face (surface on the negative X-axis side) of absorptive polarizer 12 to the front face (surface on the positive X-axis side) of substrate 11. Adhesive layer 13 has transparency to light. To improve the performance as a mirror, it is desirable that adhesive layer 13 be transparent. In plan view, adhesive layer 13 is the same size as absorptive polarizer 12. Adhesive layer 13 may be any layer that can affix absorptive polarizer 12 to substrate 11, and the material thereof, for example, is not limited in particular. For example, adhesive layer 13 may be disposed on absorptive polarizer 12 in advance. Adhesive layer 13 may contain diffusible white particles. However, it is desirable that adhesive layer 13 does not contain such white particles to improve the visibility of pictures and reflected images.

Here, in the Specification, “being transparent” refers to not only being completely transparent, that is, having a visible light transmittance of 100% but also being substantially transparent. In the Specification, “transparent” is defined as having a visible light transmittance of 90% or more.

Reflective polarizer 14 is a reflective optical member provided to project reflected images (mirror images) on mirror body 10. Reflective polarizer 14 is disposed on the side of substrate 11 adjacent to mirror component 20 (rear side; on the negative X-axis side) to reflect external light that has passed through absorptive polarizer 12 toward the outside. For example, reflective polarizer 14 reflects incident light (for example, external light that has entered first region R1) at the same angle as the angle of incidence (specular reflection). Reflective polarizer 14 allows user U to see a reflected image of themselves in first region R1 in plan view of display device 1. The external light that has passed through absorptive polarizer 12 is an example of light that vibrates in a predetermined direction (transmission axis direction of absorptive polarizer 12).

In plan view, reflective polarizer 14 has an opening in a region overlapping mirror component 20 (second region R2). In plan view, reflective polarizer 14 is provided only in first region R1 out of first region R1 and second region R2. In other words, reflective polarizer 14 is not provided in second region R2.

Reflective polarizer 14 is disposed such that the reflection axis intersects the absorption axis of absorptive polarizer 12. For example, reflective polarizer 14 is disposed such that the reflection axis is orthogonal to the absorption axis of absorptive polarizer 12. For example, reflective polarizer 14 is disposed such that the reflection axis is parallel to the transmission axis of absorptive polarizer 12. Reflective polarizer 14 is an example of a first reflective polarizer.

To obtain bright reflected images, it is desirable that reflective polarizer 14 have a high reflectance. It is desirable that the reflectance of reflective polarizer 14 alone be 40% or more, more preferably 45% or more.

Adhesive layer 15 is an adhesive member for affixing reflective polarizer 14 to substrate 11. Adhesive layer 15 has transparency to light. To improve the performance as a mirror, it is desirable that adhesive layer 15 be transparent. In plan view, adhesive layer 15 is the same size as reflective polarizer 14. That is, adhesive layer 15 is provided only in first region R1 out of first region R1 and second region R2. In other words, adhesive layer 15 is not provided in second region R2.

Adhesive layer 15 may be any layer that can affix reflective polarizer 14 to substrate 11, and the material thereof, for example, is not limited in particular. For example, adhesive layer 15 may be disposed on reflective polarizer 14 in advance. Adhesive layer 15 may contain diffusible white particles. However, it is desirable that adhesive layer 15 does not contain such white particles to improve the visibility of reflected images.

Light blocking layer 16 is provided to inhibit leakage of picture light emitted from display component 30 from regions other than second region R2 of display device 1 to the outside. Light blocking layer 16 is disposed on a side of reflective polarizer 14 adjacent to mirror component 20 (rear side) to block picture light traveling from display component 30 to reflective polarizer 14. Light blocking layer 16 inhibits leakage of picture light emitted from display component 30 into first region R1. In plan view, light blocking layer 16 is provided only in first region R1 out of first region R1 and second region R2. In other words, light blocking layer 16 is not provided in second region R2.

Light blocking layer 16 is composed of materials with light blocking properties. Printing ink or the like with light blocking properties or affixing light blocking tape may achieve light blocking layer 16. Note that light blocking layer 16 is not an essential element.

Mirror body 10 described above may further include, in second region R2 in plan view, a color correction layer for correcting coloration of external light that has passed through absorptive polarizer 12 caused by liquid crystal layer 23. The color correction layer may be colored to equalize the hue of reflected images formed by external light having entered absorptive polarizer 12 and reflected by reflective polarizer 14 (reflected images formed in first region R1) and the hue of reflected images formed by external light having entered absorptive polarizer 12 and reflected by reflective polarizer 24 (reflected images formed in second region R2).

Coloring adhesive layer 15 may achieve the color correction layer. That is, in a case where mirror component 20 has a structure, such as liquid crystal layer 23, that colors external light, adhesive layer 15 may have the function as the color correction layer for correcting the coloration. In this case, the color correction layer is disposed between substrate 11 and reflective polarizer 14. For example, such adhesive layer 15 contains desired dyes, but the configuration is not limited to this. Note that the desired dyes may be any dyes that can reduce the difference in hue between the reflected images in first region R1 and those in second region R2 (for example, a difference in spectral reflectance between reflected images in first region R1 and those in second region R2).

In the example above, the color correction layer is achieved by, but not limited to, adhesive layer 15. The color correction layer may be achieved by another layer disposed in first region R1 in plan view, may be achieved by adhesive layer 25, or may be achieved by adhesive layers 15 and 25. Moreover, the color correction layer may be achieved by another layer disposed on the front side (positive X-axis side) of reflective polarizer 14 in a sectional view, for example, another layer disposed between substrate 11 and reflective polarizer 14. For example, the color correction layer may be achieved by a colored film or may be achieved by a printed layer composed of materials containing dyes. The film and the printed layer are provided only in first region R1.

Mirror component 20 is a digital mirror disposed between mirror body 10 and display component 30 and switchable between a transmitting state (display state) in which both external light that has passed through mirror body 10 and picture light emitted from display component 30 can pass through mirror component 20 and a reflecting state in which external light that has passed through mirror body 10 is reflected by mirror component 20. For example, mirror component 20 is disposed to face mirror body 10 on the rear side of mirror body 10 and is disposed to face display component 30 on the front side of display component 30. Moreover, it can also be said that mirror component 20 is a device disposed to at least partially overlap second region R2 in plan view and switchable between the reflecting state in which external light having entered second region R2 is reflected by mirror component 20 and the display state in which picture light emitted from display component 30 can pass through mirror component 20. The reflecting state is a state in which more external light is reflected than in the transmitting state (that is, a state in which the reflectance is high).

In a case where mirror component 20 is in the reflecting state, display device 1 operates in a reflection mode (mirror mode) in which first region R1 and second region R2 function as mirrors. In a case where mirror component 20 is in the transmitting state, display device 1 operates in the display mode in which pictures from display component 30 are displayed in second region R2 out of first region R1 and second region R2. It can also be said that mirror component 20 is a device that display device 1 uses to switch between the reflection mode and the display mode. First region R1 is a region in which reflected images are displayed in both the reflection mode and the display mode. Second region R2 is a region in which reflected images are displayed in the reflection mode and in which pictures from display component 30 are displayed in the display mode. Second region R2 is a region in which images to be displayed are switched depending on the modes.

Mirror component 20 receives external light that has passed through absorptive polarizer 12 and that has not passed through other polarizers (for example, other absorptive polarizers) after passing through absorptive polarizer 12. In the present embodiment, mirror component 20 receives external light that has passed through absorptive polarizer 12 and that has not passed through reflective polarizer 14.

Mirror component 20 includes substrates 21 and 22, liquid crystal layer 23, reflective polarizer 24, and adhesive layer 25. In the present embodiment, mirror component 20 is a liquid crystal panel (liquid crystal element) including liquid crystal layer 23, but the configuration is not limited to this. Note that mirror component 20 does not include any absorptive polarizers on the front side of substrate 21. It can also be said that mirror component 20 includes only reflective polarizer 24 out of an absorptive polarizer and reflective polarizer 24. A part of absorptive polarizer 12 in second region R2 functions as an absorptive polarizer on the front side of mirror component 20. That is, mirror component 20 receives light that vibrates in the predetermined direction (for example, transmission axis direction of absorptive polarizer 12). Note that, in plan view, mirror component 20 has, but not limited to, a rectangular shape.

Substrates 21 and 22 are a pair of substrates between which liquid crystal layer 23 is interposed, and have transparency to light. Substrates 21 and 22 are composed of glass or resin members (for example, acrylic sheets) facing each other. The substrates may also be films. Although not illustrated, transparent electrodes or the like for applying voltages to liquid crystal layer 23 are formed on the inner surfaces (opposing surfaces) of substrates 21 and 22. For example, the transparent electrodes may be solid electrodes that cover second region R2.

The surface of substrate 21 adjacent to mirror body 10 (on the positive X-axis side) is an example of a first main surface that light having passed through mirror body 10 enters, whereas the surface of substrate 22 adjacent to display component 30 (on the negative X-axis side) is an example of a second main surface facing in a direction opposite to the first main surface.

Liquid crystal layer 23 is for switching mirror component 20 between the transmitting state and the reflecting state by changing the polarization direction of incident light. Liquid crystal layer 23 is an example of a switching layer that can change the polarization direction of external light that has passed through absorptive polarizer 12. Liquid crystal layer 23 changes the polarization direction of the external light based on application of voltage. For example, liquid crystal layer 23 changes the polarization direction of the external light by 90 degrees in plan view based on whether or not a voltage is applied. Note that controller 50 may control the voltage to be applied. Moreover, a switcher includes the switching layer (in the present embodiment, liquid crystal layer 23).

Liquid crystal layer 23 uniformly changes the polarization direction in second region R2. That is, the polarization direction in second region R2 is constant at any positions in plan view. For example, a uniform voltage is applied to liquid crystal layer 23.

In the case where mirror component 20 includes liquid crystal layer 23, mirror component 20 may be of the TN (Twisted Nematic) type, the VA (Vertical Alignment) type, or the IPS (In-Plane Switching) type. In the description below, mirror component 20 is of the TN type.

Moreover, mirror component 20 may include a configuration driven by active matrix driving or may include a configuration driven by passive matrix driving. Furthermore, mirror component 20 is a monochrome liquid crystal panel that displays in black and white, but may be a color liquid crystal panel that displays in color.

In the example above, the switching layer is achieved by, but not limited to, liquid crystal layer 23. The switching layer may be any layer that can change the polarization direction of external light that has passed through absorptive polarizer 12. The switching layer may be achieved by any layer, other than liquid crystal layer 23, that uses a polarizer to change the polarization direction.

Reflective polarizer 24 is a reflective optical member provided to project reflected images (mirror images) on mirror body 10 in the reflection mode. Reflective polarizer 24 is disposed between liquid crystal layer 23 and display component 30 and has a configuration that can reflect external light having passed through liquid crystal layer 23 in the reflection mode. Reflective polarizer 24 reflects external light that has passed through absorptive polarizer 12 and liquid crystal layer 23 toward the outside in the reflection mode. For example, reflective polarizer 24 reflects incident light (for example, external light that has passed through mirror body 10) at the same angle as the angle of incidence (specular reflection). The reflective properties (for example, reflectance, hue, and the like) of reflective polarizer 24 may be the same or different from those of reflective polarizer 14. It is desirable that the reflectance of reflective polarizer 24 be 40% or more, more preferably 45% or more. Moreover, for example, reflective polarizer 24 may be composed of the same material as reflective polarizer 14. Reflective polarizer 24 allows user U to see a reflected image of themselves in second region R2 in plan view of display device 1 in the reflection mode.

Reflective polarizer 24 is disposed such that the transmission axis intersects the polarization direction of light emitted from liquid crystal layer 23 toward reflective polarizer 24 in the reflection mode. For example, reflective polarizer 24 is disposed such that the transmission axis is orthogonal to the polarization direction. In other words, for example, reflective polarizer 24 is disposed such that the reflection axis is parallel to the polarization direction. Moreover, the angle formed between the reflection axis of reflective polarizer 24 and the polarization direction may be equal to the angle formed between the reflection axis of reflective polarizer 14 and the absorption axis of absorptive polarizer 12. Reflective polarizer 24 is an example of a second reflective polarizer. Note that the reflection axis and the transmission axis of reflective polarizer 24 are orthogonal to each other in plan view.

Adhesive layer 25 is an adhesive member for affixing reflective polarizer 24 to substrate 22. Adhesive layer 25 has transparency to light. To improve the performance as a mirror, it is desirable that adhesive layer 25 be transparent. In plan view, adhesive layer 25 is the same size as reflective polarizer 24. Adhesive layer 25 may be any layer that can affix reflective polarizer 24 to substrate 22, and the material thereof, for example, is not limited in particular. For example, adhesive layer 25 may be disposed on reflective polarizer 24 in advance. In a case where mirror component 20 is a liquid crystal element of a dot type, for example, adhesive layer 25 may contain diffusible white particles to inhibit the occurrence of moire patterns in displayed pictures.

For example, adhesive layer 25 may have the same thickness as adhesive layer 15 or may be composed of the same material as adhesive layer 15. Adhesive layer 25 may be the same adhesive layer as adhesive layer 15.

This reduces the difference between distorted reflection caused by ripples in adhesive layer 25 and distorted reflection caused by ripples in adhesive layer 15, thereby reducing the difference in appearance between the reflected image in first region R1 and those in second region R2 caused by the difference in distorted reflection.

Note that the switcher may include substrates 21 and 22 and liquid crystal layer 23. In this case, it can also be said that reflective polarizer 24 is disposed on a second main surface of the switcher and that reflective polarizer 24 can reflect light that has passed through the switcher.

Note that mirror component 20 may be achieved as an independent device and is an example of a mirror device.

Display component 30 is a display device that emits picture light for displaying pictures in second region R2 of mirror body 10 in the display mode. For example, display component 30 is, but not limited to, a liquid crystal display including liquid crystal panel 30a and backlight 38. For example, display component 30 is disposed to face mirror body 10 on the rear side of mirror body 10. Note that, in plan view, display component 30 has, but not limited to, a rectangular shape.

Liquid crystal panel 30a includes substrates 31 and 32, absorptive polarizers 33 and 36, adhesive layers 34 and 37, and liquid crystal layer 35. Note that display component 30 is disposed to face mirror component 20 on the rear side of mirror body 10. Moreover, in plan view, display component 30 may be larger than mirror component 20 or may be the same size as mirror component 20. In plan view, display component 30 is disposed to include a region that overlaps mirror component 20. That is, for example, mirror component 20 and display component 30 are disposed to at least partially overlap each other. Note that liquid crystal panel 30a is an example of a display panel. Moreover, FIG. 2 is a cross-sectional view illustrating a case where display component 30 and mirror component 20 are the same size in plan view.

Substrates 31 and 32 are a pair of substrates between which liquid crystal layer 35 is interposed, and have transparency to light. Substrates 31 and 32 are composed of glass or resin members (for example, acrylic sheets) facing each other. The substrates may also be films. Although not illustrated, transparent electrodes or the like for applying voltage to liquid crystal layer 35 are formed on the inner surfaces (opposing surfaces) of substrates 31 and 32.

Absorptive polarizer 33 allows the passage of light, in light that has passed through liquid crystal layer 35, vibrating in the transmission axis direction. For example, absorptive polarizer 33 is disposed such that the transmission axis intersects the absorption axis of reflective polarizer 24. For example, absorptive polarizer 33 is disposed such that the transmission axis is orthogonal to the absorption axis of reflective polarizer 24. In other words, for example, absorptive polarizer 33 is disposed such that the transmission axis is parallel to the transmission axis of reflective polarizer 24.

Adhesive layer 34 is an adhesive member for affixing absorptive polarizer 33 to substrates 31. Adhesive layer 34 has transparency to light.

Liquid crystal layer 35 is a layer for changing the polarization direction of incident light. Liquid crystal layer 35 changes the polarization direction of picture light emitted from backlight 38 and having passed through absorptive polarizer 36. Liquid crystal layer 35 changes the polarization direction of the picture light based on application of voltage.

Absorptive polarizer 36 allows the passage of light, in light emitted from backlight 38, vibrating in the transmission axis direction.

Adhesive layer 37 is an adhesive member for affixing absorptive polarizer 36 to substrate 32. Adhesive layer 37 has transparency to light.

Backlight 38 is a light source for liquid crystal panel 30a. For example, backlight 38 may include, but not limited to, a substrate and multiple light emitting devices (for example, LED (Light Emitting Diode) components) arranged on the substrate in a two-dimensional manner.

Note that backlight 38 is of the direct-lit type but may be of the edge-lit type.

The driving scheme of display component 30 described above may be any one of TN, VA, and IPS. Moreover, liquid crystal panel 30a of display component 30 is a color liquid crystal panel that displays in color, but may be a monochrome liquid crystal panel that displays in black and white.

Note that display component 30 includes liquid crystal panel 30a but may include other display panels. Display component 30 may include a light emitting panel (for example, organic EL (Electro-Luminescence) panel).

Resin layer 40 is an example of a reflection inhibitor for inhibiting multiple reflections of external light that has passed through mirror body 10 (for example, absorptive polarizer 12) between mirror body 10 and substrate 21. Resin layer 40 is composed of resin having transparency to light and disposed between mirror body 10 and mirror component 20. In the present embodiment, resin layer 40 fills a space between substrate 11 of mirror body 10 and substrate 21 of mirror component 20. Resin layer 40 is disposed to be in contact with both substrate 11 and substrate 21. That is, there is no air layer between substrate 11 and substrate 21.

For example, resin layer 40 has a refractive index closer to those of substrates 11 and 21 than to that of the air. For example, resin layer 40 may be composed of, but not limited to, acrylic resin or the like.

Controller 50 is a control device that controls constituent elements of display device 1. Controller 50 controls mirror component 20 so that mirror component 20 switches between the transmitting state and the reflecting state. Controller 50 switches mirror component 20 from one of the transmitting state and the reflecting state to the other based on, for example, inputs from user U indicating to switch display device 1 from one of the display mode and the reflection mode to the other. Moreover, controller 50 controls liquid crystal panel 30a to display desired pictures in the display mode. Controller 50 displays desired pictures based on, for example, inputs from user U indicating selected pictures. Moreover, controller 50 may further control brightness adjustment and color adjustment of backlight 38.

Controller 50 is implemented as at least one computer including nonvolatile memory that stores programs, volatile memory serving as a temporary work area, a processor that executes programs, and an input and output circuit including a communication interface and communication ports.

Note that, in a case where display device 1 includes a plurality of sets of mirror component 20 and display component 30, the configurations of the plurality of sets of mirror component 20 and display component 30 may be the same.

As described above, display device 1 according to the present embodiment includes light blocking layer 16 on the side of reflective polarizer 14 adjacent to mirror component 20 (on the negative X-axis side) to block picture light emitted from display component 30. In a sectional view, in first region R1, absorptive polarizer 12, substrate 11, reflective polarizer 14, and light blocking layer 16 are aligned in the stated order. In a sectional view, in second region R2, only absorptive polarizer 12 and substrate 11 out of absorptive polarizer 12, substrate 11, reflective polarizer 14, and light blocking layer 16 are aligned in the stated order. In a sectional view, reflective polarizer 14 and light blocking layer 16 are not disposed in second region R2.

### [2. How Light Travels in Display Device and Appearance of Display Device]

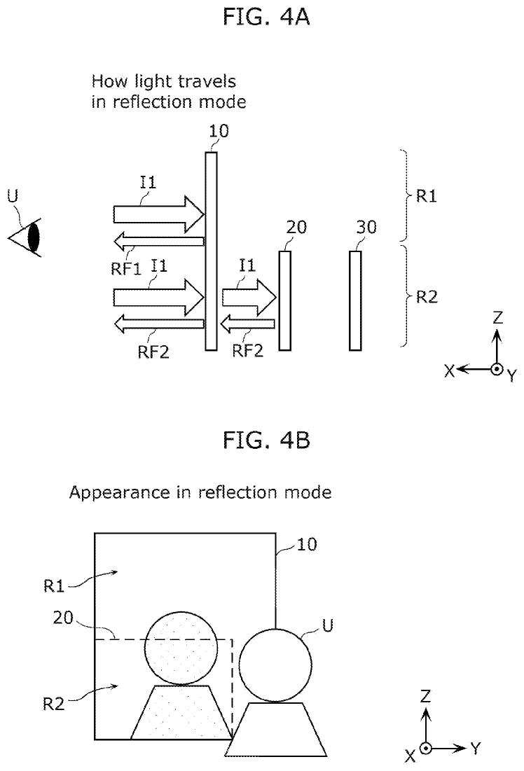

Next, how light travels in display device 1 and the appearance of display device 1 will be described with reference to FIGS. 4A to 6B. First, the reflection mode will be described. FIG. 4A is a schematic diagram illustrating how light travels when display device 1 according to the present embodiment is in the reflection mode. FIG. 4B is a schematic diagram of the appearance of display device 1 according to the present embodiment in the reflection mode. Note that FIGS. 4A to 6B illustrate an example of display device 1 including mirror component 20 and display component 30 in a lower left region (region defined by negative Y-axis and negative Z-axis; a dashed line region illustrated in FIG. 4B, for example). Moreover, the thicknesses (lengths in the Z-axis direction) of arrows illustrated in FIGS. 4A, 5A, and 6A indicate the intensity of light. Arrows with larger thicknesses indicate light rays with higher intensity. Moreover, differences in the density of dot hatching illustrated in FIGS. 4B, 5B, and 6B indicate differences in at least one of the brightness or hue of reflected images. For example, denser dot hatching indicates darker reflected images. Moreover, mirror component 20 is in the reflecting state in the reflection mode and is in the transmitting state in a display mode.

As illustrated in FIG. 4A, in the reflection mode, display device 1 according to the present embodiment emits reflected light RF1, resulting from external light I1 having entered first region R1 and then reflected by reflective polarizer 14 of mirror body 10, to the outside. Moreover, because mirror component 20 is in the reflecting state in the reflection mode, display device 1 emits reflected light RF2, resulting from external light I1 having entered second region R2, having passed through mirror body 10, and then reflected by reflective polarizer 24 of mirror component 20, to the outside. That is, in the reflection mode, first region R1 and second region R2 both function as mirrors.

Here, the reflecting state according to the present embodiment is achieved by a state of liquid crystal layer 23 (state of an array of liquid crystal molecules) changing the polarization direction of external light I1 that has passed through absorptive polarizer 12 to a direction parallel to the reflection axis of reflective polarizer 24.

As described above, display device 1 includes absorptive polarizer 12 extending over the entire surface including first region R1 and second region R2. Accordingly, the intensity and the hue of external light I1 entering reflective polarizer 14 and those of external light I1 entering mirror component 20 are equal. That is, compared with a case where an absorptive polarizer is disposed only in second region R2, display device 1 can make the intensity and the hue of reflected light RF1 and those of reflected light RF2 closer to each other. Moreover, the numbers of passages of reflected light RF1 and reflected light RF2 illustrated in FIG. 4A through an absorptive polarizer (specifically, absorptive polarizer 12) are the same.

Note that picture light is not emitted from display component 30 in the reflection mode. In the reflection mode, light emitted from backlight 38 and having passed through absorptive polarizer 36 of display component 30 is absorbed by absorptive polarizer 33 of display component 30. That is, no picture is displayed in second region R2 in the reflection mode.

As illustrated in FIG. 4B, in the reflection mode, display device 1 can make the brightness and the hue of a reflected image of user U (an upper part of the head in FIG. 4B) projected in first region R1 and those of a reflected image of user U (a lower part of the head and an upper part of the body in FIG. 4B) projected in second region R2 closer (for example, equal) to each other.

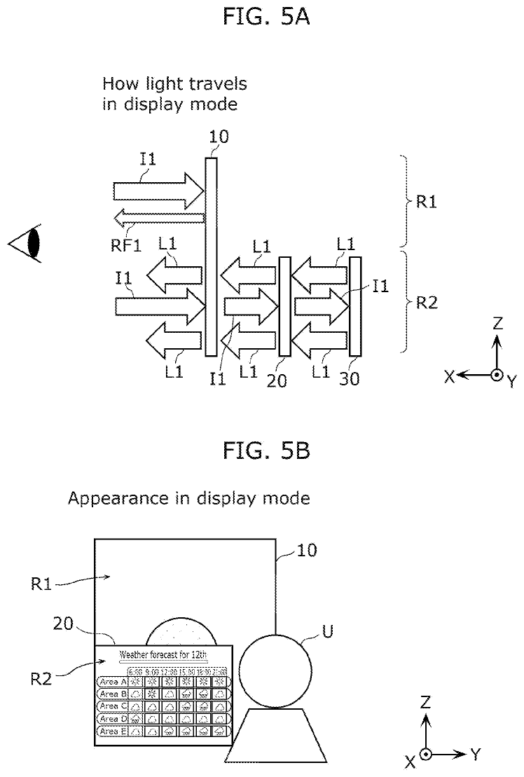

Next, the display mode will be described. FIG. 5A is a schematic diagram illustrating how light travels when display device 1 according to the present embodiment is in the display mode. FIG. 5B is a schematic diagram of the appearance of display device 1 according to the present embodiment in the display mode.

As illustrated in FIG. 5A, in the display mode, display device 1 according to the present embodiment emits reflected light RF1, resulting from external light I1 having entered first region R1 and then reflected by reflective polarizer 14 of mirror body 10, to the outside. Moreover, because mirror component 20 is in the transmitting state in the display mode, external light I1 having entered second region R2 passes through mirror component 20. That is, external light I1 is not reflected by mirror component 20 in the display mode. Moreover, because mirror component 20 is in the transmitting state, picture light L1 emitted from display component 30 passes through mirror component 20 and then through mirror body 10. Accordingly, user U can see a picture based on picture light L1 in second region R2. That is, in the display mode, first region R1 functions as a mirror, and second region R2 functions as a screen. Moreover, in the display mode, mirror component 20, which is in the transmitting state, allows external light I1 having passed through absorptive polarizer 12 and entered mirror component 20 to pass through mirror component 20 toward display component 30, and allows picture light L1 emitted from display component 30 to pass through mirror component 20 toward mirror body 10.

Here, the transmitting state according to the present embodiment is achieved by, for example, a state of liquid crystal layer 23 (state of an array of liquid crystal molecules) changing the polarization direction of external light I1 that has passed through absorptive polarizer 12 to a direction parallel to the absorption axis of reflective polarizer 24. Mirror component 20 in the transmitting state allows external light I1 that has passed through absorptive polarizer 12 to pass through mirror component 20 toward display component 30, and allows picture light L1 emitted from display component 30 to pass through mirror component 20 toward mirror body 10.

As illustrated in FIG. 5B, in the display mode, a reflected image of user U is projected in first region R1, whereas a picture based on picture light emitted from display component 30 is projected in second region R2. The reflected image projected in first region R1 in the display mode is the same as the reflected image projected in first region R1 in the reflection mode. Moreover, because external light I1 passes through mirror component 20 in the display mode, no reflected image (the lower part of the head and the upper part of the body in FIG. 5B) is projected in second region R2. Thus, display device 1 can inhibit a reduction in the visibility of pictures caused by the reflected image of user U and the picture from display component 30 displayed in second region R2, that is, can inhibit a reduction in the visibility of pictures caused by reflection. Moreover, light blocking layer 16 can inhibit pictures from being displayed in first region R1. Accordingly, display device 1 can further inhibit a reduction in the visibility of pictures.

The picture projected in second region R2 in the example illustrated in FIG. 5B is a weather forecast, but the picture to be projected is not limited to this. The picture may be the current time or advertisements. Moreover, the picture may be characters, numerical values, or symbols.

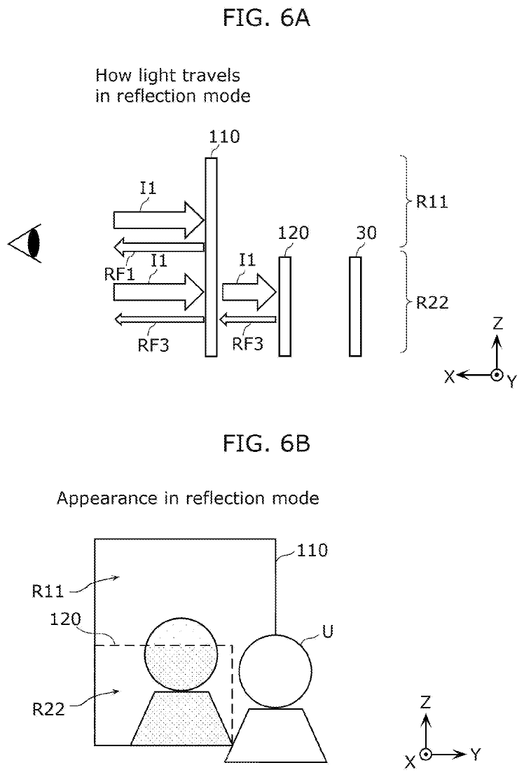

Here, the reflection mode of a display device according to a comparative example will be described. FIG. 6A is a schematic diagram illustrating how light travels when the display device according to the comparative example is in the reflection mode. FIG. 6B is a schematic diagram of the appearance of the display device according to the comparative example in the reflection mode. Mirror body 110 of the display device according to the comparative example does not include absorptive polarizer 12 of mirror body 10 according to the present embodiment, and mirror component 120 includes an absorptive polarizer disposed on a substrate on the front side of mirror component 120. That is, the display device according to the comparative example includes the absorptive polarizer only on the front face of mirror component 120 in plan view.

As illustrated in FIG. 6A, in the reflection mode, the display device according to the comparative example emits reflected light RF1, resulting from external light I1 having entered first region R11 and then reflected by reflective polarizer 14 of mirror body 110, to the outside. The reflected image in first region R11 according to the comparative example does not pass through an absorptive polarizer and thus is brighter than the reflected image in first region R1 according to the present embodiment illustrated in FIG. 4A. Moreover, because mirror component 120 is in the reflecting state in the reflection mode, the display device according to the comparative example emits reflected light RF3, resulting from external light I1 having entered second region R22, having passed through mirror body 110, and then reflected by mirror component 120, to the outside. Mirror component 120 includes the absorptive polarizer, and the reflective polarizer of mirror component 120 reflects external light I1 that has passed through the absorptive polarizer. That is, the reflective polarizer of mirror component 120 reflects external light I1 dimmed by the absorptive polarizer. Accordingly, reflected light RF3 is darker than reflected light RF2 according to the present embodiment. Moreover, the numbers of passages of reflected light RF1 and reflected light RF3 illustrated in FIG. 6A through the absorptive polarizer are different from each other.

As illustrated in FIG. 6B, in the display device according to the comparative example, the brightness and the hue of the reflected image of user U (the upper part of the head in FIG. 6B) projected in first region R11 and those of the reflected image of user U (the lower part of the head and the upper part of the body in FIG. 6B) projected in second region R22 are different from each other. The reflected image of user U projected in second region R22 can be darker than the reflected image of user U projected in first region R11. Moreover, the reflected images of user U projected in first region R11 and second region R22 may have a difference in hue according to the hue of the absorptive polarizer included in mirror component 120. In this manner, a difference in appearance between reflected images in first region R11 and in second region R22 arises in the display device according to the comparative example. That is, the uniformity of reflected images is reduced in the display device according to the comparative example, and thus user U easily identifies the presence of display component 30.

As described above, in display device 1 according to the present embodiment, mirror component 20 does not include an absorptive polarizer, and mirror body 10 includes absorptive polarizer 12 that covers entire mirror body 10 including first region R1 and second region R2. As a result, due to absorptive polarizer 12 formed to cover the whole, display device 1 can eliminate or minimize the difference in appearance between reflected images caused by the presence or absence of absorptive polarizers, which arises in the display device according to the comparative example.

### [3. Advantageous Effects Etc.]

As described above, display device 1 according to the present embodiment includes: mirror body 10 that reflects part of external light I1; display component 30 that emits picture light L1 for displaying a picture; and mirror component 20 disposed between mirror body 10 and display component 30 and switchable between a transmitting state in which mirror component 20 transmits external light I1 that has passed through mirror body 10 and picture light L1 and a reflecting state in which mirror component 20 reflects external light I1 that has passed through mirror body 10. Mirror component 20 and display component 30 are disposed to at least partially overlap each other in a plan view which is a view seen in an alignment direction in which mirror body 10, mirror component 20, and display component 30 are aligned, and mirror body 10 is larger than mirror component 20 and display component 30 in the plan view. Mirror body 10 includes: substrate 11 (an example of a plate-shaped member) having transparency to light; absorptive polarizer 12 disposed on a surface of substrate 11 and covering both first region R1 in which mirror component 20 and display component 30 are not disposed and second region R2 in which mirror component 20 and display component 30 are disposed in the plan view; and reflective polarizer 14 disposed on a side of substrate 11 adjacent to mirror component 20, including an opening in second region R2 in the plan view, and reflecting the part of external light I1. Mirror component 20 includes: liquid crystal layer 23 (an example of a switcher) capable of switching mirror component 20 between the transmitting state and the reflecting state by changing a polarization direction of external light I1 that has passed through absorptive polarizer 12 (an example of incident light); and reflective polarizer 24 (an example of a second reflective polarizer) disposed on a side of liquid crystal layer 23 adjacent to display component 30 and capable of reflecting external light I1 that has passed through mirror body 10.

Thus, compared with the case where absorptive polarizer 12 is provided only in second region R2, display device 1 has similar configurations in first region R1 and in second region R2 in a sectional view. This can reduce the difference in appearance between the reflected image in first region R1 and that of second region R2. Moreover, when display device 1 displays pictures, display device 1 brings mirror component 20 into the transmitting state so that external light I1 can pass through mirror component 20 and can be emitted toward display component 30. This inhibits reflection of external light I1. Accordingly, display device 1 can increase the visibility of reflected images while inhibiting reflection of external light.

Absorptive polarizer 12 is disposed on a surface of substrate 11 on a side opposite a side on which mirror component 20 is disposed (surface on the positive X-axis side).

Thus, compared with the case where absorptive polarizer 12 is disposed on the rear side of substrate 11, display device 1 can reduce distorted reflection in first region R1. That is, the difference in appearance between the reflected image in first region R1 and that in second region R2 can be reduced. Accordingly, in the reflection mode, display device 1 can inhibit the presence of display component 30 from being visually identified and achieve a mirror that can show uniform reflected images.

External light I1 that has passed through absorptive polarizer 12 enters the switcher without passing through an other absorptive polarizer. In other words, mirror component 20 does not include absorptive polarizers.

Thus, display device 1 can make the brightness and the hue of external light I1 entering reflective polarizer 14 and those of external light I1 entering mirror component 20 closer to each other. That is, display device 1 can make the brightness and the hue of reflected images in first region R1 and second region R2 closer to each other. Accordingly, display device 1 can increase the visibility (uniformity) of reflected images in the reflection mode.

Mirror component 20 includes a pair of substrates 21 and 22 between which the switcher is interposed, and display device 1 further includes: a reflection inhibitor for inhibiting multiple reflections of external light I1 that has passed through absorptive polarizer 12 between mirror body 10 and substrate 21, of the pair of substrates 21 and 22, which is adjacent to mirror body 10.

Thus, display device 1 can inhibit multiple reflections of external light I1 between mirror body 10 and substrate 21. That is, display device 1 can inhibit multiple images including double images from being displayed. Accordingly, display device 1 can increase the visibility of reflected images in the reflection mode.

The reflection inhibitor is resin layer 40 having transparency to light and filling a space between second region R2 of mirror body 10 and a front face of substrate 21, of the pair of substrates 21 and 22, which is adjacent to mirror body 10 (surface on the positive X-axis side).

Thus, display device 1 can inhibit multiple reflections of external light between mirror body 10 and substrate 21 using resin layer 40. Accordingly, display device 1 can increase the visibility of reflected images in the reflection mode by simply including resin layer 40.

The switcher includes liquid crystal layer 23 capable of changing the polarization direction according to whether or not a voltage is applied, and mirror body 10 further includes, in first region R1 in the plan view, a color correction layer for correcting coloration of external light I1 that has passed through absorptive polarizer 12 caused by liquid crystal layer 23.

Thus, display device 1 can reduce the difference in hue between the reflected image in first region R1 and that in second region R2. Accordingly, display device 1 can further increase the visibility of reflected images in the reflection mode.

The color correction layer is disposed between substrate 11 and reflective polarizer 14.

Thus, display device 1 can effectively perform color correction compared with a case where the color correction layer is disposed on the rear side of reflective polarizer 24.

Mirror body 10 includes adhesive layer 15 for affixing reflective polarizer 14 to a rear face of substrate 11, and the color correction layer is adhesive layer 15 subjected to coloring.

Thus, display device 1 can reduce the difference in hue between the reflected image in first region R1 and that in second region R2 without an additional layer for color correction. Accordingly, display device 1 can further increase the visibility of reflected images in the reflection mode while an increase in cost is inhibited.

Mirror body 10 includes, on a side of reflective polarizer 14 adjacent to mirror component 20, light blocking layer 16 for blocking picture light L1 traveling from display component 30 toward first region R1.

Thus, display device 1 can inhibit leakage of picture light L1 from first region R1 in the display mode. Accordingly, display device 1 can increase the visibility of pictures in the display mode.

Mirror body 10 includes, on a side of reflective polarizer 14 adjacent to mirror component 20, light blocking layer 16 for blocking picture light L1 emitted from display component 30. In a sectional view, in first region R1, absorptive polarizer 12, substrate 11, reflective polarizer 14, and light blocking layer 16 are aligned in stated order. In the sectional view, second region R2 includes only absorptive polarizer 12 and substrate 11, and absorptive polarizer 12 and substrate 11 are aligned in stated order.

Thus, in the reflection mode, display device 1 can project uniform reflected images, thereby inhibiting the presence of display component 30 from being visually identified. In addition, in the display mode, display device 1 can inhibit reflection of external light and leakage of picture light L1 emitted from display component 30. Accordingly, display device 1 can further increase the visibility of pictures in addition to the visibility of reflected images.

Display device 1 includes a plurality of sets of mirror component 20 and display component 30 disposed at positions different from each other in the plan view.

Thus, display device 1 includes a plurality of second region R2 in plan view and can display various pictures at once. Furthermore, arranging the plurality of sets of mirror component 20 and display component 30 can increase the screen size of display device 1. The sizes and shapes, in plan view, of the plurality of sets of mirror component 20 and display component 30 are not limited in particular, and may be the same or different from each other.

Display component 30 includes liquid crystal panel 30a.

Thus, display device 1 can inhibit loss of picture light L1 output from display component 30 caused by reflective polarizer 24. Accordingly, display device 1 can display brighter pictures in the display mode.

As described above, mirror component 20 (an example of a mirror device) according to the present embodiment is mirror component 20 for use in display device 1 and includes: a switcher (a switcher including liquid crystal layer 23) that includes a first main surface which light vibrating in a predetermined direction enters, and that is capable of switching mirror component 20 between a transmitting state and a reflecting state by changing a polarization direction of the light that has entered the first main surface, the transmitting state being a state in which mirror component 20 transmits the light and the reflecting state being a state in which mirror component 20 reflects the light; and reflective polarizer 24 disposed on a second main surface of the switcher that faces a direction opposite to the first main surface and capable of reflecting the light that has passed through the switcher. Mirror component 20 includes only reflective polarizer 24 out of an absorptive polarizer and reflective polarizer 24.

Thus, when display device 1 displays pictures, mirror component 20 enters the transmitting state to allow passage of external light I1 and to emit external light I1 rearward (for example, toward display component 30). This inhibits reflection of external light I1. Moreover, when mirror component 20 is included in display device 1 including reflective polarizer 14 with an opening at a position where mirror component 20 is disposed, both the reflected image reflected by reflective polarizer 14 and the reflected image reflected by reflective polarizer 24 are formed by light reflected by the respective reflective polarizers, resulting in a reduction in the difference in appearance between the reflected images. Accordingly, mirror component 20 can increase the visibility of reflected images while inhibiting reflection of external light by being included in display device 1.

### Variation 1 of Embodiment

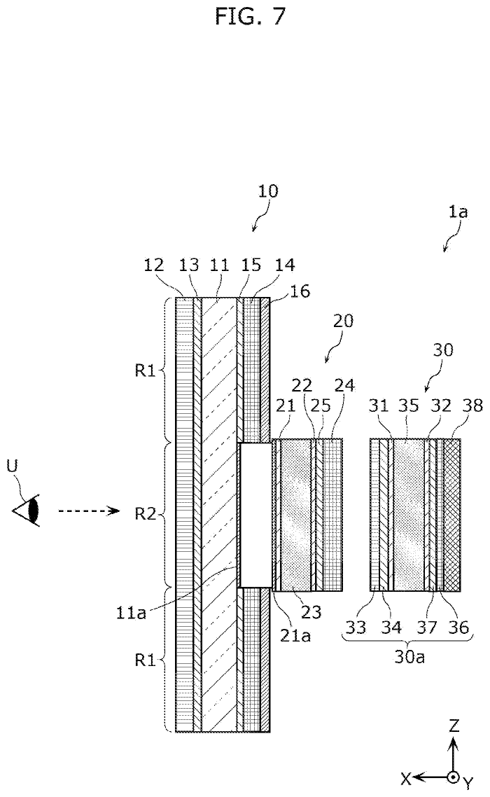

A display device according to the present variation will now be described with reference to FIG. 7. FIG. 7 is a cross-sectional view, corresponding to line II-II in FIG. 1, of display device 1a according to the present variation. Display device 1a according to the present variation differs from display device 1 according to the embodiment in including reflection inhibition layers 11a and 21a. The following primarily describes how display device 1a according to the present variation is different from display device 1 according to the embodiment. Moreover, configurations identical or similar to those of display device 1 according to the embodiment will be denoted by the same reference numbers and symbols used for display device 1 according to the embodiment, and descriptions thereof will be omitted or simplified.

As illustrated in FIG. 7, display device 1a according to the present variation includes reflection inhibition layers 11a and 21a instead of resin layer 40 of display device 1 according to the embodiment. Reflection inhibition layers 11a and 21a are an example of the reflection inhibitor for inhibiting multiple reflections of external light that has passed through mirror body 10 between mirror body 10 and substrate 21. A space (air layer) lies between reflection inhibition layers 11a and 21a.

Reflection inhibition layer 11a is an AR (Anti Reflection) layer disposed on the rear face (surface on the negative X-axis side) of substrate 11. In plan view, reflection inhibition layer 11a need only be formed in second region R2 out of first region R1 and second region R2. Reflection inhibition layer 21a is an AR layer disposed on the front face of substrate 21. Reflection inhibition layers 11a and 21a are disposed to face each other.

For example, reflection inhibition layers 11a and 21a are composed of multilayered dielectric thin films. Reflection inhibition layers 11a and 21a may be formed by applying AR coating or by affixing AR sheets. For example, at least one of substrate 11 or substrate 21 may be AR glass with AR coating.

The reflectance of reflection inhibition layers 11a and 21a is, but not limited to, 0.5% or less, for example.

As described above, the reflection inhibitor of display device 1a according to the present variation is reflection inhibition layers 11a and 21a respectively formed on the rear face of mirror body 10 in second region R2 and on the front face (surface on the positive X-axis side) of substrate 21.

Thus, display device 1a can inhibit multiple reflections of external light between mirror body 10 and substrate 21 using reflection inhibition layers 11a and 21a. Accordingly, display device 1a can increase the visibility of pictures by simply including reflection inhibition layers 11a and 21a. Moreover, reflection inhibition layers 11a and 21a can also be formed on substrates 11 and 21, respectively, in advance. This reduces the time required to produce display device 1.

### Variation 2 of Embodiment

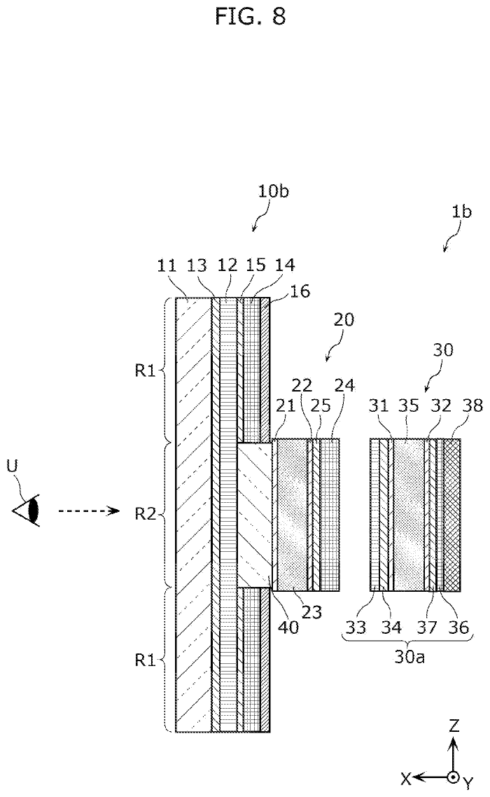

A display device according to the present variation will now be described with reference to FIG. 8. FIG. 8 is a cross-sectional view, corresponding to line II-II in FIG. 1, of display device 1b according to the present variation. Display device 1b according to the present variation differs from display device 1 according to the embodiment in including absorptive polarizer 12 on the rear side (negative X-axis side) of substrate 11. The following primarily describes how display device 1b according to the present variation is different from display device 1 according to the embodiment. Moreover, configurations identical or similar to those of display device 1 according to the embodiment will be denoted by the same reference numbers and symbols used for display device 1 according to the embodiment, and descriptions thereof will be omitted or simplified.

As illustrated in FIG. 8, display device 1b according to the present variation includes mirror body 10b instead of mirror body 10 of display device 1 according to the embodiment.

Mirror body 10b includes substrate 11, absorptive polarizer 12, adhesive layer 13, reflective polarizer 14, adhesive layer 15, and light blocking layer 16. Mirror body 10b according to the present variation includes substrate 11, adhesive layer 13, absorptive polarizer 12, adhesive layer 15, reflective polarizer 14, and light blocking layer 16 aligned in the stated order.

Absorptive polarizer 12 is disposed on the rear side (negative X-axis side) of substrate 11. Specifically, absorptive polarizer 12 is disposed between substrate 11 and reflective polarizer 14. In plan view, absorptive polarizer 12 extends over first region R1 and second region R2 on the rear side of substrate 11. In the present variation, absorptive polarizer 12 covers entire first region R1 and second region R2 from the rear side of substrate 11.

Adhesive layer 13 affixes the rear face of substrate 11 and the front face of absorptive polarizer 12 to each other.

Resin layer 40 is composed of resin having transparency to light and disposed between mirror body 10b and mirror component 20. In the present variation, resin layer 40 fills a space between absorptive polarizer 12 of mirror body 10b and substrate 21 of mirror component 20. Resin layer 40 is disposed to be in contact with both absorptive polarizer 12 and substrate 21. That is, there is no air layer between absorptive polarizer 12 and substrate 21.

As described above, absorptive polarizer 12 of display device 1b according to the present variation is disposed between substrate 11 and reflective polarizer 14.

Thus, absorptive polarizer 12 is not disposed on the front face (surface on the positive X-axis side) of display device 1b, and thereby absorptive polarizer 12 is inhibited from being directly sighted by user U. Moreover, substrate 11 disposed in front of absorptive polarizer 12 (for example, at the forefront) can inhibit absorptive polarizer 12 from coming into contact with outside air, water drops, or the like. This can increase the durability of display device 1b.

### Variation 3 of Embodiment

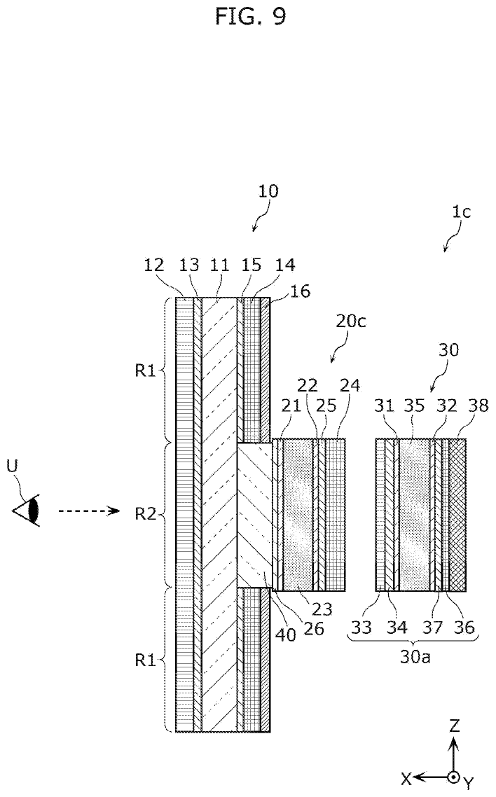

A display device according to the present variation will now be described with reference to FIG. 9. FIG. 9 is a cross-sectional view, corresponding to line II-II in FIG. 1, of display device 1c according to the present variation. Display device 1c according to the present variation differs from display device 1 according to the embodiment in including optical compensation film 26 on the front side (positive X-axis side) of substrate 21. The following primarily describes how display device 1c according to the present variation is different from display device 1 according to the embodiment. Moreover, configurations identical or similar to those of display device 1 according to the embodiment will be denoted by the same reference numbers and symbols used for display device 1 according to the embodiment, and descriptions thereof will be omitted or simplified.

As illustrated in FIG. 9, display device 1c according to the present variation includes mirror component 20c instead of mirror component 20 of display device 1 according to the embodiment. Mirror component 20c includes optical compensation film 26 between substrate 21 and resin layer 40. In the present variation, optical compensation film 26 is a viewing angle correction film. However, optical compensation film 26 is not limited to the viewing angle correction film and may be a brightness enhancement film, a retardation film, or the like or a combination thereof.

The viewing angle correction film is intended to reduce dependence of liquid crystal panel 30a on viewing angle. Such dependence includes changes in displayed colors and contrast ratios according to viewing directions. The viewing angle correction film exhibits anisotropy in refractive index. Placing the viewing angle correction film between absorptive polarizer 12 and liquid crystal layer 23 can reduce effects of optical anisotropy of absorptive polarizer 12, liquid crystal layer 23, and the like on pictures and can increase optical performance of display device 1c in terms of viewing angle.

Optical compensation film 26 reduces effects of optical anisotropy of at least one of absorptive polarizer 12, mirror component 20c (for example, liquid crystal layer 23), or liquid crystal panel 30a on pictures. Optical compensation film 26 capable of reducing the optical anisotropy of mirror component 20c (for example, liquid crystal layer 23) and liquid crystal panel 30a can increase the viewing angle of pictures in the display mode and can eliminate or minimize the difference in appearance between first region R1 and second region R2 in the reflection mode. Moreover, optical compensation film 26 capable of reducing the optical anisotropy of mirror component 20c (for example, liquid crystal layer 23) can eliminate or minimize the difference in appearance between first region R1 and second region R2 in the reflection mode.

Optical compensation film 26 is disposed on the front side (positive X-axis side) of substrate 21. For example, optical compensation film 26 is disposed between substrate 11 and substrate 21. For example, optical compensation film 26 is spaced from display component 30.

Note that, in a case of the configuration illustrated in FIG. 9, an optical compensation film having the same optical properties as optical compensation film 26 may be disposed between substrate 11 and reflective polarizer 14 of mirror body 10. This can eliminate or minimize the difference in appearance between first region R1 and second region R2 caused by the presence or absence of optical compensation film 26 in the reflection mode.

As described above, display device 1c according to the present variation includes optical compensation film 26 between substrate 11 (an example of the plate-shaped member) and liquid crystal layer 23 (an example of the switcher). Optical compensation film 26 is a viewing angle compensation film, for example.

Thus, in the case where display component 30 includes liquid crystal panel 30a, display device 1c can increase the viewing angle of pictures.

Note that optical compensation film 26 may be disposed between absorptive polarizer 33 and liquid crystal layer 35, for example. In this case, optical compensation film 26 and absorptive polarizer 33 may be integral to each other. Moreover, in this case, optical compensation film 26 does not need to be provided for mirror body 10.

### Other Embodiments

Although display devices according to the present disclosure have been described above based on the embodiment and variations (hereinafter also referred to as “embodiment and the like”), the embodiment and the like above are not intended to limit the present disclosure.

For example, the absorptive polarizer in the embodiment and the like above may include a retardation plate (for example, quarter wave plate).

Moreover, the substrates are flat in the embodiment and the like above, but the shape is not limited to this. The substrates may be partially curved in a sectional view.

Moreover, the absorptive polarizer of the mirror body is affixed directly to the substrate with the adhesive layer in the embodiment and the like above, but the configuration is not limited to this. The display device may include another layer (for example, another optical member) between the absorptive polarizer and the substrate extending over the first region and the second region in plan view. Moreover, placing the absorptive polarizer on the front face of the substrate includes affixing the absorptive polarizer directly to the front face of the substrate with the adhesive layer and affixing the absorptive polarizer to the front face of the substrate with the other layer and the adhesive layer.

Moreover, the reflective polarizer of the mirror body is affixed directly to the rear face of the substrate with the adhesive layer in the embodiment and the like above, but the configuration is not limited to this. The display device may include another layer (for example, another optical member) between the reflective polarizer and the substrate extending over the first region and the second region in plan view.

Moreover, the display component is disposed to face the mirror component in the embodiment and the like above, but the configuration is not limited to this. For example, the display device may have a configuration that causes picture light emitted from the display component to be reflected by a mirror or the like and to enter the mirror component. In this case, the display component and the mirror component do not need to be disposed to face each other.

Moreover, the securing method for the mirror body, the mirror component, and the display component in the embodiment and the like above is not limited in particular. Those elements may be respectively secured using securing members (not illustrated), or the mirror body may support the mirror component and the display component to support the units.

The present disclosure also encompasses other forms obtained by making various modifications conceivable to those skilled in the art to each embodiment and the like, as well as forms implemented by freely combining constituent elements and functions of each embodiment and the like without departing from the essence of the present disclosure.

### INDUSTRIAL APPLICABILITY

The present disclosure is applicable for display devices with mirror bodies.

### REFERENCE SIGNS LIST

1, 1a, 1b, 1c display device
10, 10b mirror body
11 substrate (plate-shaped member)
11a, 21a reflection inhibition layer (reflection inhibitor)
12, 33, 36 absorptive polarizer
13, 15, 25, 34, 37 adhesive layer
14 reflective polarizer (first reflective polarizer)
16 light blocking layer
20 mirror component
21, 22, 31, 32 substrate
23 liquid crystal layer (switching layer)
24 reflective polarizer (second reflective polarizer)
26 optical compensation film
30 display component
30a liquid crystal panel
35 liquid crystal layer
38 backlight
40 resin layer (reflection inhibitor)
50 controller
I1 external light
L1 picture light
R1 first region
R2 second region
RF1, RF2 reflected light
U user

1. A display device comprising:
a mirror body that reflects part of external light;
a display component that emits picture light for displaying a picture; and
a mirror component disposed between the mirror body and the display component and switchable between a transmitting state in which the mirror component transmits the external light that has passed through the mirror body and the picture light and a reflecting state in which the mirror component reflects the external light that has passed through the mirror body, wherein
the mirror component and the display component are disposed to at least partially overlap each other in a plan view which is a view seen in an alignment direction in which the mirror body, the mirror component, and the display component are aligned, and the mirror body is larger than the mirror component and the display component in the plan view,
the mirror body includes:
a plate-shaped member having transparency to light;
an absorptive polarizer disposed on a surface of the plate-shaped member and covering both a first region in which the mirror component and the display component are not disposed and a second region in which the mirror component and the display component are disposed in the plan view; and
a first reflective polarizer disposed on a side of the plate-shaped member adjacent to the mirror component, including an opening in the second region in the plan view, and reflecting the part of the external light, and
the mirror component includes:
a switcher capable of switching the mirror component between the transmitting state and the reflecting state by changing a polarization direction of incident light; and
a second reflective polarizer disposed on a side of the switcher adjacent to the display component and capable of reflecting the external light that has passed through the mirror body.

2. The display device according to claim 1, wherein
the absorptive polarizer is disposed on a surface of the plate-shaped member on a side opposite a side on which the mirror component is disposed.

3. The display device according to claim 1, wherein
the absorptive polarizer is disposed between the plate-shaped member and the first reflective polarizer.

4. The display device according to claim 1, wherein
the external light that has passed through the absorptive polarizer enters the switcher without passing through an other absorptive polarizer.

5. The display device according to claim 4, wherein
the mirror component includes a pair of substrates between which the switcher is interposed,
the display device further comprising:
a reflection inhibitor for inhibiting multiple reflections of the external light that has passed through the absorptive polarizer between the mirror body and a substrate, of the pair of substrates, which is adjacent to the mirror body.

6. The display device according to claim 5, wherein
the reflection inhibitor is a resin layer having transparency to light and filling a space between the second region of the mirror body and a front face of the substrate, of the pair of substrates, which is adjacent to the mirror body.

7. The display device according to claim 5, wherein
the reflection inhibitor includes a reflection inhibition layer disposed on a rear face of the mirror body in the second region and a reflection inhibition layer disposed on a front face of the substrate, of the pair of substrates, which is adjacent to the mirror body.

8. The display device according to claim 1, wherein
the switcher includes a liquid crystal layer capable of changing the polarization direction according to whether or not a voltage is applied, and
the mirror body further includes, in the first region in the plan view, a color correction layer for correcting coloration of the external light that has passed through the absorptive polarizer caused by the liquid crystal layer.

9. The display device according to claim 8, wherein
the color correction layer is disposed between the plate-shaped member and the first reflective polarizer.

10. The display device according to claim 8, wherein
the mirror body includes an adhesive layer for affixing the first reflective polarizer to a rear face of the plate-shaped member, and
the color correction layer is the adhesive layer subjected to coloring.

11. The display device according to claim 1, wherein
the mirror body includes, on a side of the first reflective polarizer adjacent to the mirror component, a light blocking layer for blocking the picture light traveling from the display component toward the first region.

12. The display device according to claim 1, wherein
the mirror body includes, on a side of the first reflective polarizer adjacent to the mirror component, a light blocking layer for blocking the picture light emitted from the display component,
in a sectional view, in the first region, the absorptive polarizer, the plate-shaped member, the first reflective polarizer, and the light blocking layer are aligned in stated order, and
in the sectional view, the second region includes only the absorptive polarizer and the plate-shaped member, and the absorptive polarizer and the plate-shaped member are aligned in stated order.

13. The display device according to claim 1, comprising:
a plurality of sets of the mirror component and the display component disposed at positions different from each other in the plan view.

14. The display device according to claim 1, wherein
the display component includes a liquid crystal panel.

15. The display device according to claim 14, comprising:
a viewing angle compensation film between the plate-shaped member and the switcher.

16. A mirror device for use in a display device, the mirror device comprising:
a switcher that includes a first main surface which light vibrating in a predetermined direction enters, and that is capable of switching the mirror device between a transmitting state and a reflecting state by changing a polarization direction of the light that has entered the first main surface, the transmitting state being a state in which the mirror device transmits the light and the reflecting state being a state in which the mirror device reflects the light; and
a reflective polarizer disposed on a second main surface of the switcher that faces a direction opposite to the first main surface and capable of reflecting the light that has passed through the switcher, wherein
the mirror device includes only the reflective polarizer out of an absorptive polarizer and the reflective polarizer.
